(19) United States
(12) Patent Application Publication
(10) Pub. No.: US 2018/0194466 A1
(43) Pub. Date: Jul. 12, 2018

(54) UNMANNED AERIAL VEHICLE, METHOD OF PROVIDING AIRBORNE REPLENISHMENT, AERIAL PLATFORM AND CONTROL METHOD THEREOF

(71) Applicant: SZ DJI TECHNOLOGY CO., LTD., Shenzhen (CN)

(72) Inventors: Kaiyong ZHAO, Shenzhen (CN); Mingxi WANG, Shenzhen (CN); Xiangyu CHEN, Shenzhen (CN)

(21) Appl. No.: 15/913,406

(22) Filed: Mar. 6, 2018

Related U.S. Application Data
(63) Continuation of application No. PCT/CN2015/088992, filed on Sep. 6, 2015.

(51) Int. Cl. B64C 39/02; G05D 1/10; G05D 1/06; G05D 1/00

(52) U.S. Cl. CPC B64C 39/024; G05D 1/102; G05D 1/0676; B64C 2201/141; B64C 2201/042; B64C 2201/066; B64C 2201/123; G05D 1/0088

(57) ABSTRACT

An unmanned aerial vehicle (UAV) includes a detection device configured to generate a supplement demand signal in response to a need of the UAV for resource supplement, a wireless communication device configured to establish a wireless communication connection with at least one aerial platform and communicate with the at least one aerial platform in response to the supplement demand signal being generated, and a flight control device configured to determine a target aerial platform from the at least one aerial platform, generate a flight control signal based upon communication information of the target aerial platform received by the wireless communication device, and adjust a spatial distance between the UAV and the target aerial platform based upon the flight control signal to enable an airborne replenishment to the UAV by the target aerial platform.

### CROSS-REFERENCE TO RELATED APPLICATION

This application is a continuation application of the International Application No. PCT/CN2015/088992, filed on Sep. 6, 2015, the entire contents of which are incorporated herein by reference.

### TECHNICAL FIELD

The present disclosure relates to a control of unmanned aerial vehicles (UAVs), and more particularly to an UAV, a method of providing airborne replenishment to the UAV, an aerial platform for providing airborne replenishment to the UAV, and a method of controlling the aerial platform.

### BACKGROUND OF THE DISCLOSURE

Compact unmanned aerial vehicles (UAVs) can hover or perform a flight at low altitude and low velocity, and have been developed for various applications including land surveying and mapping, high precision aerial photography, surveillance and other fields. For a compact UAV performing a long range flight task, a regular battery replacement or raw material refilling is needed due to a limited capacity of onboard battery and a limited load capacity. The existing UAVs may land onto stationery ground stations for the battery replacement or raw material refilling, which may significantly reduce an effective flight time of the UAV due to time and power spent in flying to and from the ground station. Therefore, the flight of UAV may be limited to specific areas surrounding the ground station because the ground station is stationery. In addition, ground stations for landing and replenishing UAVs may not be suitable for some environments such as sea or forest area.

### SUMMARY OF THE DISCLOSURE

In accordance with the disclosure, there is provided an unmanned aerial vehicle (UAV) including a detection device configured to generate a supplement demand signal in response to a need of the UAV for resource supplement, a wireless communication device configured to establish a wireless communication connection with at least one aerial platform and communicate with the at least one aerial platform in response to the supplement demand signal being generated, and a flight control device configured to determine a target aerial platform from the at least one aerial platform, generate a flight control signal based upon communication information of the target aerial platform received by the wireless communication device, and adjust a spatial distance between the UAV and the target aerial platform based upon the flight control signal to enable an airborne replenishment to the UAV by the target aerial platform.

Also in accordance with the disclosure, there is provided a method of providing airborne replenishment to an unmanned aerial vehicle (UAV). The method includes generating a supplement demand signal in response to a need of the UAV for resource supplement, establishing a wireless communication connection with at least one aerial platform and communicating with the at least one aerial platform in response to the supplement demand signal being generated, determining a target aerial platform from the at least one aerial platform, generating a flight control signal based upon communication information of the target aerial platform received from the target aerial platform, and adjusting a spatial distance between the UAV and the target aerial platform based upon the flight control signal to enable the airborne replenishment to the UAV by the target aerial platform

### BRIEF DESCRIPTION OF THE DRAWINGS

FIG. 1 shows a replenishment system for an unmanned aerial vehicle (UAV) in accordance with embodiments of the disclosure.

FIG. 2 shows a structure of a UAV in accordance with embodiments of the disclosure.

FIG. 3 shows a first preset marker in accordance with embodiments of the disclosure.

FIG. 4 shows a second preset marker in accordance with embodiments of the disclosure.

FIG. 5 shows a flow chart of a method of providing airborne replenishment to a UAV in accordance with embodiments of the disclosure.

FIG. 6 shows a structure of an aerial platform in accordance with embodiments of the disclosure.

FIG. 7 shows a UAV landed on a replenishment station of the aerial platform of FIG. 6 in accordance with embodiments of the disclosure.

FIG. 8 shows a flow chart of a method of controlling an aerial platform in accordance with embodiments of the disclosure.

### LIST OF REFERENCE NUMERALS

TABLE 1

| | |
|---|---|
| Unmanned aerial vehicle replenishment | 100 |
| system | |
| Unmanned aerial vehicle (UAV) | 20 |
| Detection device | 21 |
| First wireless communication device | 22 |
| Propulsion assembly | 23 |
| Flight control device | 24 |
| Power supply device | 25 |
| Power receiving device | 251 |
| Charging device | 252 |
| Battery | 253 |
| Positioning device | 261 |
| Altitude measurement device | 262 |
| Proximity sensor | 27 |
| Functional device | 28 |
| Imaging device | 281 |
| Stabilizing device | 282 |
| Storage device | 29 |
| Aerial platform | 30 |
| Levitating device | 301 |
| Second wireless communication device | 302 |
| Positioning device | 3031 |
| Altitude measurement device | 3032 |
| Controller | 304 |
| Propulsion assembly | 305 |
| Replenishment station | 31 |
| Carrier base | 311 |
| Guiding member | 312 |
| Replenishment device | 313 |
| Landing area | 314 |
| Battery station | 315 |
| Power transmission device | 316 |
| Detection device | 317 |
| Step | 501-504, 801-803 |

Embodiments of the present disclosure will be described in more detail with reference to the drawings.

### DETAILED DESCRIPTION OF THE DISCLOSURE

A better understanding of the disclosure will be obtained by reference to the following detailed description that sets forth illustrative embodiments with reference to the drawings. It will be apparent that the embodiments described herein are merely provided by way of example only. Those skilled in the art can conceive other embodiments in light of those embodiments disclosed herein without inventive efforts, and all these embodiments are within the scope of the disclosure.

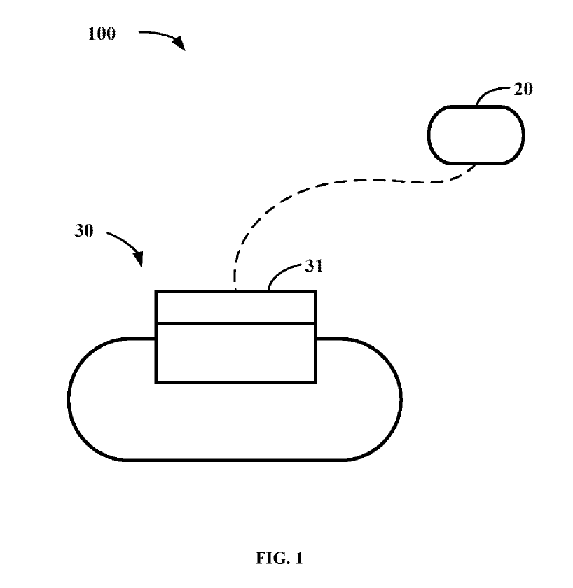

Referring to FIG. 1, an unmanned aerial vehicle (UAV) replenishment system 100 in accordance with embodiments of the disclosure is shown. The UAV replenishment system 100 includes at least one UAV 20 and at least one aerial platform 30. In some embodiments, each aerial platform 30 can carry resource supplement, hover or move in the air, and provide a platform for the UAV 20 to land and receive supply. For example, the aerial platform 30 can be utilized to autonomously change a battery or a load of the UAV 20, charge the battery of the UAV 20, or refill raw materials for the UAV 20.

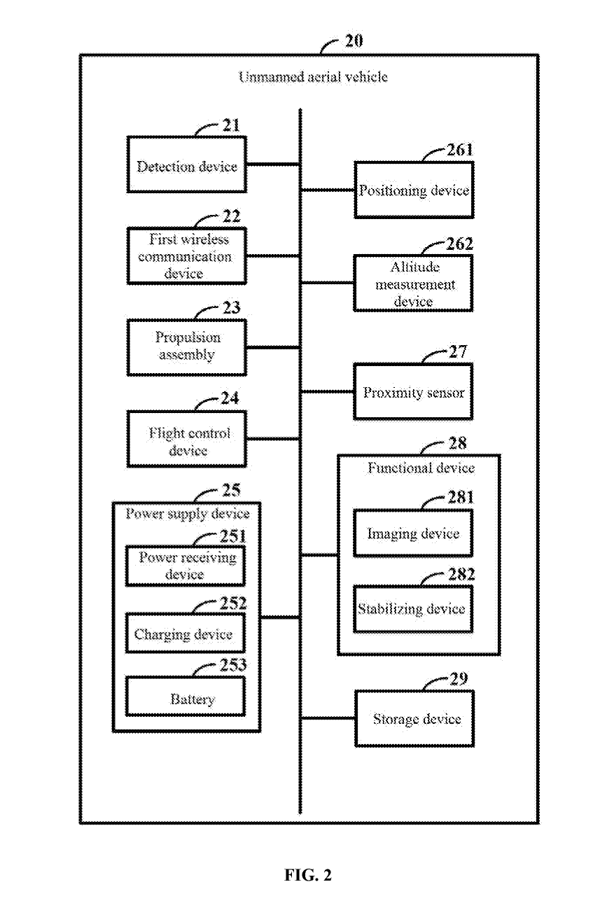

Referring to FIG. 2, a structure of the UAV 20 in accordance with embodiments of the disclosure is shown. The UAV 20 includes a detection device 21, a first wireless communication device 22, a propulsion assembly 23, and a flight control device 24. In some embodiments, the propulsion assembly 23 can be configured to provide a propulsion to the UAV 20. The flight control device 24 can adjust flight parameters of the UAV 20 by controlling a propulsion output of the propulsion assembly 23. In some embodiments, the propulsion assembly 23 can comprise an electronic speed regulator, a motor, and a propeller. The flight control device 24 can be electrically connected to the electronic speed regulator, the electronic speed regulator can be electrically connected to the motor, and the motor can be connected to the propeller. The electronic speed regulator can output a speed regulation signal to the motor based upon a corresponding motor speed control signal provided from the flight control device 24 so as to control the motor to rotate at a specified speed. The motor can drive the propeller to rotate to provide a lift for the UAV 20.

The detection device 21 can generate a supplement demand signal when it detects that the UAV 20 has a need for resource supplement. In some embodiments, the need for resource supplement can include charging a battery or changing a battery. Accordingly, the detection device 21 can be a power detection circuit. For instance, the power detection circuit can determine that the battery capacity is low if the power detection circuit detects that a capacity of the battery is below a preset threshold. In other words, the power detection circuit can generate a power supplement demand signal when the UAV 20 has a need for resource supplement including charging the battery or changing the battery. In some embodiments, the supplement demand signal can comprise a signal to direct the aerial platform to prepare for wireless charging, wired charging, or a battery replacement.

In some embodiments, the need for resource supplement can include replacing a load or refilling a raw material. Accordingly, the detection device 21 can be a load state detection device or a raw material amount detection device. For instance, the load state detection device can determine that the UAV 20 has a need for resource supplement to change a load if the load state detection device detects that the load onboard the UAV 20 operates abnormally. For another instance, the raw material amount detection device can determine that the UAV 20 has a need for resource supplement to refill the raw material if the raw material amount detection device (for example, a water level detector or an oil level detector) detects that a level of a raw material in a raw material reservoir onboard the UAV 20 is below a preset level. In some embodiments, the supplement demand signal can include a signal to direct the aerial platform to prepare to replace a load or refill a raw material.

Once the supplement demand signal is generated, the first wireless communication device 22 can establish a wireless communication connection with at least one aerial platform 30 and communicate with the connected aerial platform 30. For instance, the first wireless communication device 22 can establish the wireless communication connection and communicate with the at least one aerial platform 30 through a wireless communication including but not limited to Bluetooth, GPS, WI-FI, 2G network, 3G network, 4G network, or 5G network.

In some embodiments, the flight control device 24 can determine a target aerial platform 30 based upon communication information received by the first wireless communication device 22 from the connected aerial platform 30.

For instance, in determining the target aerial platform 30, the flight control device 24 can calculate a spatial distance between the UAV 20 and the connected aerial platforms 30 and determine an aerial platform 30 having a shortest spatial distance to the UAV 20 as the target aerial platform 30 based upon the communication information.

In some embodiments, the communication information can include at least one of position information and altitude information of the connected aerial platform 30, or a strength of a wireless signal transmitted from the connected aerial platform 30.

In some embodiments, as shown in FIG. 2, the UAV 20 further includes a positioning device 261, such as a GPS positioning device, for obtaining position information of the UAV 20, and an altitude measurement device 262, such as a barometer, for measuring altitude information of the UAV 20.

In some embodiments, the flight control device 24 can calculate the spatial distance between the UAV 20 and the connected aerial platform 30 based upon the position information and the altitude information of the UAV 20 and the connected aerial platform 30. For instance, the flight control device 24 can calculate a horizontal distance between the UAV 20 and the connected aerial platform 30 based upon the position information of the UAV 20 and the connected aerial platform 30, calculate a vertical distance between the UAV 20 and the connected aerial platform 30 based upon the altitude information of the UAV 20 and the connected aerial platform 30, and calculate the spatial distance based upon the horizontal distance and the vertical distance.

In some embodiments, the flight control device 24 can calculate the spatial distance between the UAV 20 and the connected aerial platform 30 based upon the strength of the wireless signal transmitted from the connected aerial platform 30.

In some embodiments, the communication information can include state information of the connected aerial platform 30. The state information can include at least one of a resource adequate and standby state, a resource adequate but busy state, or a resource inadequate state.

In some embodiments, the flight control device 24 can ignore those aerial platforms 30 having state information of resource inadequate state and/or busy state before calculating the spatial distance between the UAV 20 and the connected aerial platform 30 based upon the communication information. Therefore, a valid aerial platform 30, for example an aerial platform 30 having a resource adequate and standby state and a shortest spatial distance to the UAV 20, can be determined as the target aerial platform 30. As a result, the UAV 20 can be prevented from landing on an aerial platform being occupied, an aerial platform having inadequate resource, or a remote aerial platform, so as to reduce an energy consumption of the UAV 20 and/or the aerial platform 30 and avoid accidents of the UAV 20 due to an energy shortage.

In some embodiments, the flight control device 24 can control the first communication device 22 to send the supplement demand signal to the target aerial platform 30 once the target aerial platform 30 is determined, such that the target aerial platform 30 can prepare for providing airborne replenishment in response to the supplement demand signal.

Once the target aerial platform 30 is determined, the flight control device 24 can generate a flight control signal and adjust the spatial distance between the UAV 20 and the target aerial platform 30 based upon the flight control signal, such that the target aerial platform 30 can be enabled to provide airborne replenishment to the UAV 20.

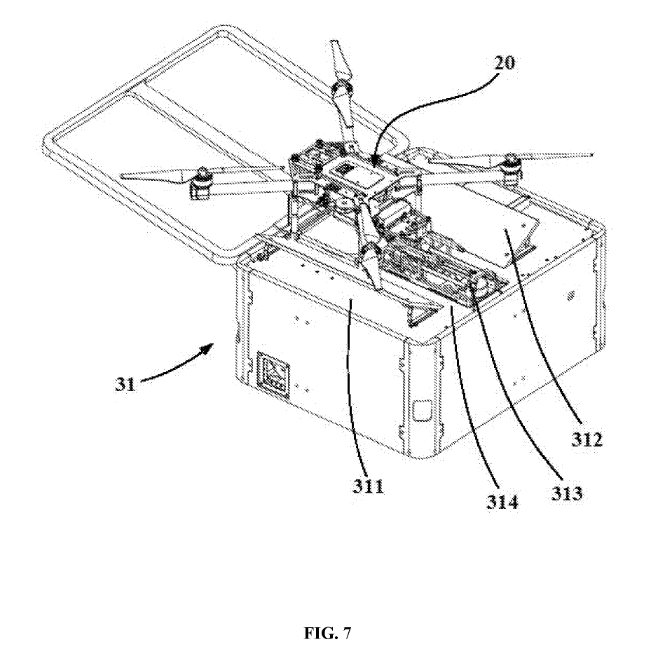

In some embodiments, the flight control device 24 can adjust flight parameters of the UAV 20 to land the UAV 20 onto a landing area 314 (shown in FIG. 7) of the target aerial platform 30 to effect the airborne replenishment provided by the target aerial platform 30.

The flight control device 24 can direct the first wireless communication device 22 to communicate with the target aerial platform 30 periodically or in real-time to obtain real-time communication information of the target aerial platform 30 and provide real-time communication information of the UAV 20 to the target aerial platform 30. The real-time communication information of the target aerial platform 30 can include at least one of position information and altitude information of the target aerial platform 30, or a strength of the wireless signal transmitted from the target aerial platform 30. The real-time communication information of the UAV 20 can include at least one of position information and altitude information of the UAV 20, or a strength of the wireless signal transmitted from the UAV 20.

In order to control the UAV 20 to approach the target aerial platform 30, in some embodiments, the flight control device 24 can adjust flight parameters of the UAV 20 based upon the flight control signal and the real-time communication information of the target aerial platform 30, and direct the UAV 20 to move in a direction toward the target aerial platform 30. In other words, the UAV 20 can actively approach the target aerial platform 30.

In some embodiments, the flight control device 24 can control the first wireless communication device 22 to send the flight control signal to the target aerial platform 30, and direct the target aerial platform 30 to move in a direction toward the UAV 20 in response to the flight control signal. This way, the UAV 20 can be prevented from accidents such as a crash due to an insufficient energy for a flight to the aerial platform 30. Meanwhile, the UAV 20 can maintain at an operation spot and continue to perform the operation, so as to reduce energy and time consumed in flying between the operation spot and the target aerial platform 30.

In some embodiments, the flight control device 24 can adjust flight parameters of the UAV 20 based upon the flight control signal and the real-time communication information of the target aerial platform, and direct the UAV 20 to move in a direction toward the target aerial platform 30. In the meantime, the flight control device 24 can control the first wireless communication device 22 to send the flight control signal to the target aerial platform 30, and direct the target aerial platform 30 to move in a direction toward the UAV 20 in response to the flight control signal. In other words, both the UAV 20 and the target aerial platform 30 can move toward each other, such that the UAV 20 can land onto the target aerial platform 30 as quickly as possible to reduce the time required to provide supply for the UAV 20.

The flight control device 24 can determine a flight direction of the UAV 20 based upon the real-time communication information of the target aerial platform 30.

In some embodiments, the flight control device 24 can determine the flight direction of the UAV 20 based upon the position information and the altitude information of the UAV 20 and the target aerial platform 30.

In some embodiments, the flight control device 24 can determine the flight direction of the UAV 20 by determining a direction in which the strength of the wireless signal transmitted from the target aerial platform 30 is increasing. Thus, the UAV 20 can move toward a signal source (for example, the target aerial platform 30 transmitting the wireless signal) by moving in the direction in which the signal strength is increasing.

The flight control device 24 can calculate a real-time spatial distance between the UAV 20 and the target aerial platform 30 based upon the real-time communication information of the target aerial platform 30.

In some embodiments, the flight control device 24 can calculate the real-time spatial distance between the UAV 20 and the target aerial platform 30 based upon the position information and the altitude information of the UAV 20 and the target aerial platform 30. It will be appreciated that, in case the UAV 20 moves and the target aerial platform 30 remains stationary, the position information and the altitude information of the UAV 20 can change in real-time while the position information and the altitude information of the target aerial platform 30 can remain unchanged. In case the UAV 20 remains stationary and the target aerial platform 30 moves, the position information and the altitude information of the UAV 20 can remain unchanged while the position information and the altitude information of the target aerial platform 30 can change in real-time. In case both the UAV 20 and the target aerial platform 30 move, the position information and the altitude information of both the UAV 20 and the target aerial platform 30 can change in real-time.

In some embodiments, the flight control device 24 can calculate the real-time spatial distance between the UAV 20 and the target aerial platform 30 based upon the strength of the wireless signal transmitted from the target aerial platform 30.

In some embodiments, as shown in FIG. 2, the UAV 20 includes an imaging device 281 for aerial photography. The imaging device 281 can be a high-resolution digital camera, an optical camera, or an electronic device having an imaging functionality. In some embodiments, the UAV 20 further includes a stabilizing device 282 for supporting and stabilizing the imaging device 281, and adjusting an imaging direction and orientation of the imaging device 281. The stabilizing device 282 can be a gimbal or another device capable of stabilizing the imaging device 281. For instance, the stabilizing device 282 can include a damping structure (for example, a damping pad, a damping ball, or a damping spring) and a rotating mechanism. The damping structure can reduce or eliminate a vibration experienced by the imaging device 281 due to, e.g., a vibration of the UAV 20 and/or an air turbulence. The rotating mechanism can change an orientation of the imaging device 281. The rotating mechanism can be a single-axis, two-axis, or three-axis rotating mechanism. In some embodiments, the stabilizing device 282 can be omitted, and the imaging device 281 can be directly coupled to the UAV 20.

In some embodiments, the flight control device 24 can direct the imaging device 281 onboard the UAV 20 to capture images of the surrounding environment if the spatial distance between the UAV 20 and the target aerial platform 30 is less than or equal to a preset distance (for example, 100 meters), i.e., when the UAV 20 is in proximity to the target aerial platform 30. In some embodiments, the flight control device 24 can activate the imaging device 281 to image the surrounding environment. In some embodiments, the imaging device 281 can be maintained in a power on state.

In some embodiments, the UAV 20 and/or the target aerial platform 30 can continue to move toward each other if the spatial distance is greater than the preset distance, i.e., when the real-time spatial distance between the UAV 20 and the target aerial platform 30 is relatively large.

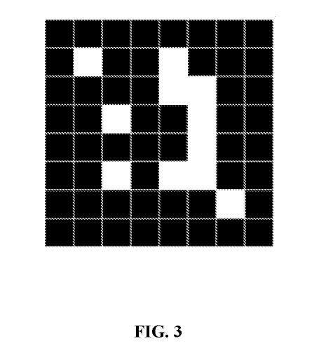

In some embodiments, the flight control device 24 can analyze the captured images. If a first preset marker is recognized from the captured images, the flight control device 24 can determine a position of the target aerial platform 30 based upon the first preset marker and adjust the flight parameters of the UAV 20 according to a guidance of the first preset marker, so as to direct the UAV 20 to move in a direction toward the position of the target aerial platform 30. In some embodiments, the first preset marker can be a pattern (such as the one shown in FIG. 3) provided in advance (for example, painted on or adhered to) on at least one side of the target aerial platform 30. The first preset marker can be a letter, a number, a geometric shape, a QR code, a barcode, or the like. The first preset marker can guide the UAV 20 to move toward the target aerial platform 30.

In some embodiments, the first preset marker can be provided in advance on more than one side of the target aerial platform 30 to facilitate the imaging device 281 of the UAV 20 to capture the first preset marker. This arrangement can avoid a situation where the imaging device 281 cannot capture the first preset marker because the UAV 20 and the first preset marker are positioned at different sides of the target aerial platform 30.

In some embodiments, when directing the UAV 20 to approach the position of the target aerial platform 30, the flight control device 24 can control the movement of the UAV 20 such that the first preset marker remains within a central region of the image captured by the imaging device 281 that contains the first preset marker. For instance, a geometric center of the first preset marker (e.g., a circle center) can be maintained at the center of the image.

In some embodiments, if the first preset marker is not recognized from the captured images, the flight control device 24 can direct the imaging device 281 to capture new images after the UAV 20 and/or the target aerial platform 30 has moved for a period of time or a spatial distance or when an increase in signal strength reaches a threshold. This process can be repeated until the first preset marker is recognized from the images. In some embodiments, the flight control device 24 can direct the imaging device 281 to continuously capture real-time images during a flight of the UAV 20 and/or the target aerial platform 30, until the first preset marker is recognized from the images. In some embodiments, the imaging device 281 can continuously capture real-time images without a control of the flight control device 24.

In some embodiments, during the flight of the UAV 20 and/or the target aerial platform 30, the flight control device 24 can direct a proximity sensor 27 (for example, an ultrasonic sensor, a radar, or other distance measurement sensors) onboard the UAV 20 to detect the spatial distance between the UAV 20 and the target aerial platform 30 in real-time when the spatial distance between the UAV 20 and the target aerial platform 30 is less than or equal to the preset distance. Using the proximity sensor 27 can improve a precision in distance measurement.

In some embodiments, the flight control device 24 can estimate the spatial distance between the UAV 20 and the target aerial platform 30 based upon an imaging parameter of the imaging device 281 and properties of the first preset marker as recognized from the image. In some instances, the imaging parameter can include a focal length of the imaging device 281, and the properties of the first preset marker can include at least a size or a clarity of the first preset marker.

The preset distance is not limited to the examples described hereinabove, but can be set according to specific circumstance.

In some embodiments, the flight control device 24 can adjust flight parameters of the UAV 20 in a vertical direction to land the UAV 20 onto the landing area 314 of the target aerial platform 30 (as shown in FIG. 7) based upon the altitude information of the UAV 20 and the target aerial platform 30 if the spatial distance between the UAV 20 and the target aerial platform 30 is less than or equal to a threshold distance (for example, 50 meters). In some embodiments, the threshold distance can be less than the preset distance. The threshold distance is not limited to the example described hereinabove, but can be set according to specific circumstance.

In some embodiments, the flight control device 24 can send a flight termination signal to the target aerial platform 30. A flight of the target aerial platform 30 can be terminated in response to the flight termination signal to avoid a collision with the UAV. In some instances, the flight control device 24 can control the first wireless communication device 22 to transmit the flight termination signal to the target aerial platform 30 to terminate a flight of the target aerial platform 30 in response to the flight termination signal.

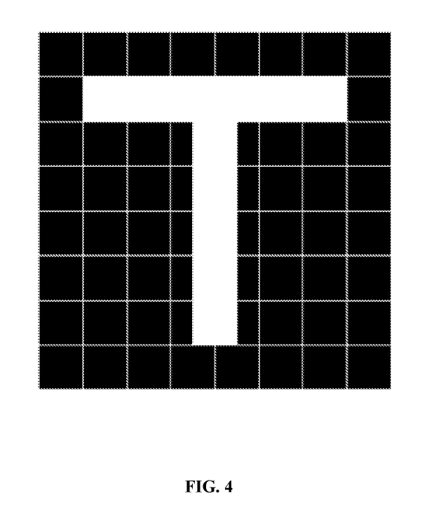

The flight control device 24 can control the imaging device 281 to capture an image of the target aerial platform 30 and analyze the image. If a second preset marker is recognized from the captured image, the flight control device 24 can determine a position of the landing area 314 based upon the second preset marker and adjust the flight parameters of the UAV 20 according to a guidance of the second preset marker, so as to direct the UAV 20 to land onto the landing area 314 of the target aerial platform 30. In some embodiments, the second preset marker can be a pattern provided in advance (for example, painted on or adhered to) on the landing area 314 of the target aerial platform 30 (as shown in FIG. 4). The second preset marker can be a letter, a number, a geometric shape, a QR code, a barcode, or the like. The second preset marker can guide the UAV 20 to land precisely onto the landing area 314 of the target aerial platform 30. In this way, the flight control device 24 can direct the UAV 20 to autonomously land onto the landing area 314 of the target aerial platform 30 by recognizing the second preset marker provided on the target aerial platform 30.

In some embodiments, when directing the UAV 20 to land onto the landing area 314 of the target aerial platform 30, the flight control device 24 can control the movement of the UAV 20 such that the second preset marker remains within a central region of the image captured by the imaging device 281 that contains the second preset marker. For instance, a geometric center of the second preset marker (e.g., a circle center) can be maintained at the center of the image.

In some embodiments, in order to ensure a precise landing of the UAV 20, the flight control device 24 can direct the imaging device 281 to continuously capture images of the second preset marker and adjust the flight parameters of the UAV 20 in real-time based upon the second preset marker and the spatial distance, such that the UAV 20 can precisely land onto the landing area 314 of the target aerial platform 30.

In some embodiments, if the second preset marker is not recognized from the captured images, the flight control device 24 can adjust the flight parameters of the UAV 20 in the vertical direction based upon the altitude information of the UAV 20 and the target aerial platform 30 to direct the UAV 20 to move above the target aerial platform 30. In the meantime, the flight control device 24 can direct the imaging device 281 to capture new images of the target aerial platform 30 until the second preset marker is recognized from the new images. This can avoid the situation where the imaging device 281 cannot capture the second preset marker of the target aerial platform 30 when the UAV 20 is below the target aerial platform 30.

In some embodiments, as shown in FIG. 2, the UAV 20 further includes a storage device 29 for storing in advance image information of the first preset marker and the second preset marker associated with the at least one aerial platform 30. The first preset marker can be a pattern provided in advance on at least one side of the aerial platform 30. The second preset marker can be a pattern provided in advance on the landing area 314 of the aerial platform 30. In some embodiments, a size of the first preset marker can be larger than a size of the second preset marker, such that the first preset marker can be captured by the UAV 20 at a longer distance.

In some embodiments, the flight control device 24 can recognize the first preset marker or the second preset marker from the captured images based upon a fitting error of contour of grayscale image.

An airborne replenishment can be provided to the UAV 20 by the target aerial platform 30 when the UAV 20 is landed on the landing area 314 of the target aerial platform 30.

In some embodiments, as shown in FIG. 2, the UAV 20 further includes a power supply device 25. In some embodiments, as shown in FIG. 2, the power supply device 25 includes at least one exchangeable battery 253, which can be changed by the aerial platform 30. The flight control device 24 can direct to shut down a functional device 28, such as the imaging device 281 and/or the stabilizing device 282, onboard the UAV 20 before the battery is being changed. The flight control device 24 can direct the power supply device 25 to shut down and terminate powering after the functional device 28 is shut down, such that the UAV 20 is brought into a powered off state.

In some embodiments, the power supply device 25 can include at least two batteries. The UAV 20 can be powered by at least one battery during the battery changing to prevent data loss.

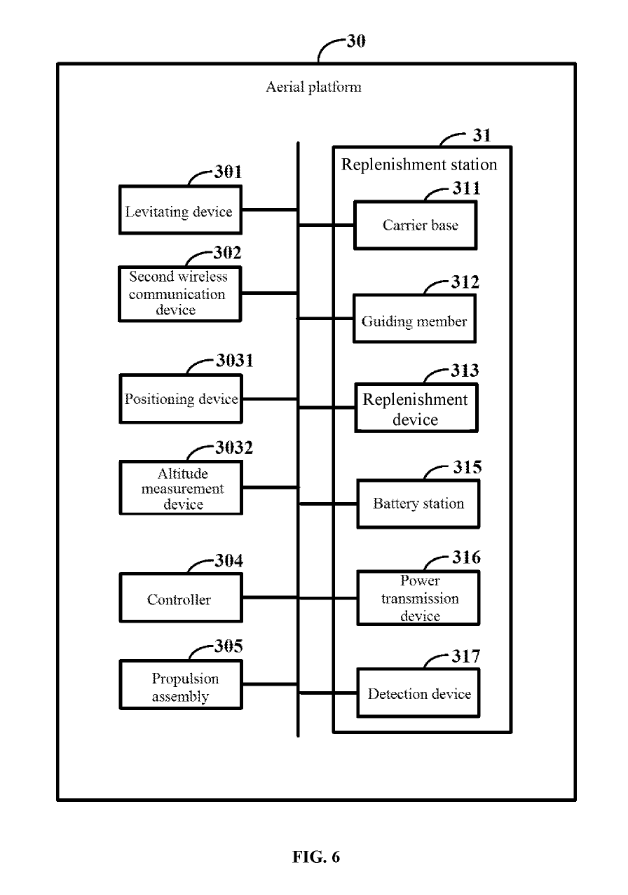

In some embodiments, as shown in FIG. 2, the power supply device 25 includes a power receiving device 251, a charging device 252, and a battery 253. The power receiving device 251 can be electrically coupled to a power transmission device 316 (shown in FIG. 6) provided on the target aerial platform 30 and receive power transmitted from the power transmission device 316. The charging device 252 can receive the power and charge the battery 253. In some embodiments, a wireless power transmission can be effected between the power receiving device 251 and the power transmission device 316 provided on the target aerial platform 30 via a wireless connection. Therefore, wireless battery charging can be effected by a high frequency induction without a precise landing of the UAV 20 onto the target aerial platform 30 or removing the battery. In this way, the charging process can be simplified, and an efficiency and intelligence of battery charging can be improved. In this case, the positioning device for assisting the UAV 20 in landing onto the landing area 314 of the aerial platform 30 can be omitted from the UAV 20 and the aerial platform 30.

In some embodiments, the UAV 20 can include a raw material reservoir (not shown) for receiving and carrying a raw material supplied by the target aerial platform 30.

The UAV 20 provided in the disclosure can preliminarily determine a position of the target aerial platform 30 based upon the position information and altitude information of the target aerial platform 30. The UAV 20 can further determine a position of the target aerial platform 30 based upon the recognized first preset marker of the target aerial platform 30 when the UAV 20 is in proximity to the target aerial platform 30. The UAV 20 can then determine a precise position of the target aerial platform 30 based upon the recognized second preset marker of the target aerial platform 30 and land onto the target aerial platform 30 to autonomously receive a resource supplement.

In some embodiments, the target aerial platform 30 can provide airborne charging to the UAV 20. The communication information received by the first wireless communication device 22 from the target aerial platform 30 can include at least the position information and the altitude information of the target aerial platform 30. The flight control device 24 can determine an effective wireless charging area based upon the position information and altitude information of the UAV 20 and the target aerial platform 30. The flight control device can adjust flight parameters of the UAV 20 to direct the UAV 20 to autonomously move into the effective wireless charging area to receive wireless charging from the target aerial platform 30. Additionally or alternatively, the flight control device 24 can direct the target aerial platform 30 to move toward the UAV 20 by sending the flight control signal to the target aerial platform 30 through the first wireless communication device 22, such that the UAV 20 can be within the effective wireless charging area to receive wireless charging from the target aerial platform 30.

In some instances, the flight control device 24 can generate a charging control signal when the UAV 20 is within the effective wireless charging area. The power receiving device 251 of the UAV 20 and the power transmission device 316 of the target aerial platform 30 can establish a wireless connection in response to the charging control signal and wirelessly transmit an electric power. Therefore, wireless battery charging can be effected by a high frequency induction without landing the UAV 20 onto the target aerial platform 30 or removing the battery. In this way, the charging process can be simplified, and an efficiency and intelligence of battery charging can be improved.

In some embodiments, once the wireless power transmission is effected between the power receiving device 251 of the UAV 20 and the power transmission device 316 of the target aerial platform 30, the flight control device 24 can adjust flight parameters of the UAV 20 to maintain the UAV 20 within the effective wireless charging area, or direct the UAV 20 to land onto the landing area 314 of the target aerial platform 30 to avoid an energy consumption in maintaining a flight of the UAV 20.

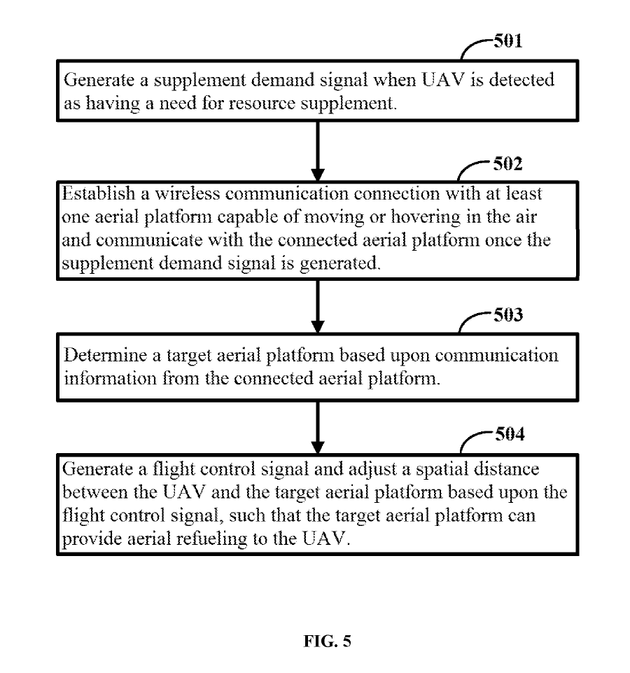

FIG. 5 shows a flow chart of a method of providing airborne replenishment to an UAV 20 in accordance with embodiments of the disclosure. The method of providing airborne replenishment to the UAV 20 can direct the UAV 20 as described hereinabove to autonomously determine a valid aerial platform 30 and receive resource supplement.

As shown in FIG. 5, at 501, a supplement demand signal is generated by the detection device 21 when the detection device 21 detects that the UAV 20 has a need for resource supplement.

In some embodiments, the need for resource supplement can include charging a battery or changing a battery. Accordingly, the detection device 21 can be a power detection circuit. For instance, the power detection circuit can determine that the battery capacity is low if the power detection circuit detects that a capacity of the battery is below a preset threshold. In other words, the power detection circuit can generate a power supplement demand signal when the UAV 20 has a need for resource supplement to charge the battery or change the battery. In some embodiments, the supplement demand signal can include a signal to direct the aerial platform to prepare for a wireless charging, a wired charging, or a battery replacement.

In some embodiments, the need for resource supplement can include replacing a load or refilling a raw material. Accordingly, the detection device 21 can be a load state detection device or a raw material amount detection device. For instance, the load state detection device can determine that the UAV 20 has a need for resource supplement to change a load if the load state detection device detects that the load onboard the UAV 20 operates abnormally. For another instance, the raw material amount detection device can determine that the UAV 20 has a need for resource supplement to refill the raw material if the raw material amount detection device (for example, a water level detector or an oil level detector) detects that a level of a raw material in a raw material reservoir onboard the UAV 20 is below a preset level. In some embodiments, the supplement demand signal can comprise a signal to direct the aerial platform to prepare for a load replacement or a raw material refilling.

At 502, the first wireless communication device 22 establishes a wireless communication connection with at least one aerial platform 30 and communicate with the connected aerial platform 30 once the supplement demand signal is generated. For instance, the first wireless communication device 22 can establish the wireless communication connection and communicate with the at least one aerial platform 30 through a wireless communication including but not limited to Bluetooth, GPS, WI-FI, 2G network, 3G network, 4G network, or 5G network.

At 503, the flight control device 24 determines a target aerial platform 30 based upon communication information received by the first wireless communication device 22 from the connected aerial platform 30.

For instance, in determining the target aerial platform 30, the flight control device 24 can calculate a spatial distance between the UAV 20 and the connected aerial platforms 30 and determine an aerial platform 30 having a shortest spatial distance to the UAV 20 as the target aerial platform 30 based upon the communication information.

In some embodiments, the communication information can comprise at least one of position information and altitude information of the connected aerial platform 30, or a strength of a wireless signal transmitted from the connected aerial platform 30.

In some embodiments, the flight control device 24 can calculate the spatial distance between the UAV 20 and the connected aerial platform 30 based upon the position information and the altitude information of the UAV 20 and the connected aerial platform 30. For instance, the flight control device 24 can calculate a horizontal distance between the UAV 20 and the connected aerial platform 30 based upon the position information of the UAV 20 and the connected aerial platform 30, calculate a vertical distance between the UAV 20 and the connected aerial platform 30 based upon the altitude information of the UAV 20 and the connected aerial platform 30, and calculate the spatial distance based upon the horizontal distance and the vertical distance.

In some embodiments, the flight control device 24 can calculate the spatial distance between the UAV 20 and the connected aerial platform 30 based upon the strength of the wireless signal transmitted from the connected aerial platform 30.

In some embodiments, the communication information can include state information of the connected aerial platform 30. The state information can include at least one of a resource adequate and standby state, a resource adequate but busy state, or a resource inadequate state.

In some embodiments, the flight control device 24 can ignore those aerial platforms 30 having state information of resource inadequate state and/or busy state before calculating the spatial distance between the UAV 20 and the connected aerial platform 30 based upon the communication information. Therefore, a valid aerial platform 30, for example an aerial platform 30 having a resource adequate and standby state and a shortest spatial distance to the UAV 20, can be determined as the target aerial platform 30. As a result, the UAV 20 can be prevented from landing on an aerial platform being occupied, an aerial platform having inadequate resource, or a remote aerial platform, so as to reduce an energy consumption of the UAV 20 and/or the aerial platform 30, and avoid accidents of the UAV 20 due to an energy shortage.

In some embodiments, the flight control device 24 can control the first communication device 22 to send the supplement demand signal to the target aerial platform 30 once the target aerial platform 30 is determined, such that the target aerial platform 30 can prepare for providing airborne replenishment in response to the supplement demand signal.

At 504, the flight control device 24 generates a flight control signal and adjust the spatial distance between the UAV 20 and the target aerial platform 30 based upon the flight control signal, such that the target aerial platform 30 can be enabled to provide airborne replenishment to the UAV 20.

In some embodiments, the flight control device 24 can adjust flight parameters of the UAV 20 to land the UAV 20 onto a landing area 314 of the target aerial platform 30 to effect the airborne replenishment provided by the target aerial platform 30.

The flight control device 24 can control the first wireless communication device 22 to communicate with the target aerial platform 30 periodically or in real-time to obtain real-time communication information of the target aerial platform 30 and provide real-time communication information of the UAV 20 to the target aerial platform 30. The real-time communication information of the target aerial platform 30 can comprise at least one of position information and altitude information of the target aerial platform 30, or a strength of the wireless signal transmitted from the target aerial platform 30. The real-time communication information of the UAV 20 can include at least one of position information and altitude information of the UAV 20, or a strength of the wireless signal transmitted from the UAV 20.

In order to control the UAV 20 to approach the target aerial platform 30, in some embodiments, the flight control device 24 can adjust flight parameters of the UAV 20 based upon the flight control signal and the real-time communication information of the target aerial platform 30, and direct the UAV 20 to move in a direction toward the target aerial platform 30. In other words, the UAV 20 can actively approach the target aerial platform 30.

In some embodiments, the flight control device 24 can control the first wireless communication device 22 to send the flight control signal to the target aerial platform 30, and direct the target aerial platform 30 to move in a direction toward the UAV 20 in response to the flight control signal. This way, the UAV 20 can be prevented from accidents such as a crash due to an insufficient energy for a flight to the aerial platform 30. Meanwhile, the UAV 20 can maintain its position and continue performing its task to reduce energy and time consumed by the UAV 20 in flying between a position where the task is being performed and the target aerial platform 30.

In some embodiments, the flight control device 24 can adjust flight parameters of the UAV 20 based upon the flight control signal and the real-time communication information of the target aerial platform, and direct the UAV 20 to move in a direction toward the target aerial platform 30. In the meantime, the flight control device 24 can control the first wireless communication device 22 to send the flight control signal to the target aerial platform 30, and direct the target aerial platform 30 to move in a direction toward the UAV 20 in response to the flight control signal. In other words, both the UAV 20 and the target aerial platform 30 can move toward each other, such that the UAV 20 can land onto the target aerial platform 30 in a reduced time before receiving resource supplement.

The flight control device 24 can determine a flight direction of the UAV 20 based upon the real-time communication information of the target aerial platform 30.

In some embodiments, the flight control device 24 can determine the flight direction of the UAV 20 based upon the position information and the altitude information of the UAV 20 and the target aerial platform 30.

In some embodiments, the flight control device 24 can determine the flight direction of the UAV 20 based upon a direction in which the strength of the wireless signal transmitted from the target aerial platform 30 is increasing. Thus, the UAV 20 can move toward a signal source (for example, the target aerial platform 30 transmitting the wireless signal) by moving in the direction in which the signal strength is increasing.

The flight control device 24 can calculate a real-time spatial distance between the UAV 20 and the target aerial platform 30 based upon the real-time communication information of the target aerial platform 30.

In some embodiments, the flight control device 24 can calculate the real-time spatial distance between the UAV 20 and the target aerial platform 30 based upon the position information and the altitude information of the UAV 20 and the target aerial platform 30. It will be appreciated that, in case the UAV 20 moves and the target aerial platform 30 remains stationary, the position information and the altitude information of the UAV 20 can change in real-time while the position information and the altitude information of the target aerial platform 30 can remain unchanged. In case the UAV 20 remains stationary and the target aerial platform 30 moves, the position information and the altitude information of the UAV 20 can remain unchanged while the position information and the altitude information of the target aerial platform 30 can change in real-time. In case both the UAV 20 and the target aerial platform 30 move, the position information and the altitude information of both the UAV 20 and the target aerial platform 30 can change in real-time.

In some embodiments, the flight control device 24 can calculate the real-time spatial distance between the UAV 20 and the target aerial platform 30 based upon the strength of the wireless signal transmitted from the target aerial platform 30.

In some embodiments, the flight control device 24 can direct an imaging device 281 onboard the UAV 20 to capture images of the surrounding environment if the spatial distance between the UAV 20 and the target aerial platform 30 is less than or equal to a preset distance (for example, 100 meters), i.e., when the UAV 20 is in proximity to the target aerial platform 30. In some embodiments, the flight control device 24 can activate the imaging device 281 to image the surrounding environment. In some embodiments, the imaging device 281 can be maintained in a power on state.

In some embodiments, the UAV 20 and/or the target aerial platform 30 can continue to move toward each other if the spatial distance is greater than the preset distance, i.e., when the real-time spatial distance between the UAV 20 and the target aerial platform 30 is relatively large.

In some embodiments, the flight control device 24 can analyze the captured images. If a first preset marker is recognized from the captured images, the flight control device 24 can determine a position of the target aerial platform 30 based upon the first preset marker and adjust the flight parameters of the UAV 20 according to a guidance of the first preset marker, so as to direct the UAV 20 to move in a direction toward the position of the target aerial platform 30. In some embodiments, the first preset marker can be a pattern (such as the one shown in FIG. 3) provided in advance (for example, painted on or adhered to) on at least one side of the target aerial platform 30. The first preset marker can be a letter, a number, a geometric shape, a QR code, a barcode, or the like. The first preset marker can guide the UAV 20 to move toward the target aerial platform 30.

In some embodiments, the first preset marker can be provided in advance on more than one side of the target aerial platform 30 to facilitate the imaging device 281 of the UAV 20 in capturing the first preset marker. This arrangement can avoid a situation where the imaging device 281 cannot capture the first preset marker because the UAV 20 and the first preset marker are positioned at different sides of the target aerial platform 30.

In some embodiments, when directing the UAV 20 to approach the position of the target aerial platform 30, the flight control device 24 can control the movement of the UAV 20 such that the first preset marker remains within a central region of the image captured by the imaging device 281 that contains the first preset marker. For instance, a geometric center of the first preset marker (e.g., a circle center) can be maintained at the center of the image.

In some embodiments, if the first preset marker is not recognized from the captured images, the flight control device 24 can direct the imaging device 281 to capture new images after the UAV 20 and/or the target aerial platform 30 has moved for a period of time or a spatial distance or when an increase in signal strength reaches a threshold. This process can be repeated until the first preset marker is recognized from the images. In some embodiments, the flight control device 24 can direct the imaging device 281 to continuously capture real-time images during a flight of the UAV 20 and/or the target aerial platform 30, until the first preset marker is recognized from the images. In some embodiments, the imaging device 281 can continuously capture real-time images without a control of the flight control device 24.

In some embodiments, during the flight of the UAV 20 and/or the target aerial platform 30, the flight control device 24 can direct a proximity sensor 27 (for example, an ultrasonic sensor, a radar, or other distance measurement sensors) onboard the UAV 20 to detect the spatial distance between the UAV 20 and the target aerial platform 30 in real-time when the spatial distance between the UAV 20 and the target aerial platform 30 is less than or equal to the preset distance. Using the proximity sensor 27 can improve a precision in distance measurement.

In some embodiments, the flight control device 24 can estimate the spatial distance between the UAV 20 and the target aerial platform 30 based upon an imaging parameter of the imaging device 281 and properties of the first preset marker as recognized from the image. In some instances, the imaging parameter can include a focal length of the imaging device 281, and the properties of the first preset marker can include at least a size or a clarity of the first preset marker.

It will be appreciated that, the preset distance is not limited to the example as described hereinabove, but can be set according to specific circumstance.

In some embodiments, the flight control device 24 can adjust flight parameters of the UAV 20 in a vertical direction to land the UAV 20 onto the landing area 314 of the target aerial platform 30 if the spatial distance between the UAV 20 and the target aerial platform 30 is less than or equal to a threshold distance (for example, 50 meters). In some embodiments, the threshold distance can be less than the preset distance. The threshold distance is not limited to the example described hereinabove, but can be set according to specific circumstance.

In some embodiments, the flight control device 24 can send a flight termination signal to the target aerial platform 30. A flight of the target aerial platform 30 can be terminated in response to the flight termination signal to avoid a collision with the UAV. In some instances, the flight control device 24 can control the first wireless communication device 22 to transmit the flight termination signal to the target aerial platform 30 to terminate a flight of the target aerial platform 30 in response to the flight termination signal.

The flight control device 24 can control the imaging device 281 to capture an image of the target aerial platform 30 and analyze the image. If a second preset marker is recognized from the captured image, the flight control device 24 can determine a position of the landing area 314 based upon the second preset marker and adjust the flight parameters of the UAV 20 according to a guidance of the second preset marker, so as to direct the UAV 20 to land onto the landing area 314 of the target aerial platform 30. In some embodiments, the second preset marker can be a pattern provided in advance (for example, painted on or adhered to) on the landing area 314 of the target aerial platform 30 (as shown in FIG. 4). The second preset marker can be a letter, a number, a geometric shape, a QR code, a barcode, or the like. The second preset marker can guide the UAV 20 to land precisely onto the landing area 314 of the target aerial platform 30. In this way, the flight control device 24 can direct the UAV 20 to autonomously land onto the landing area 314 of the target aerial platform 30 by recognizing the second preset marker provided on the target aerial platform 30.

In some embodiments, when directing the UAV 20 to land onto the landing area 314 of the target aerial platform 30, the flight control device 24 can control the movement of the UAV 20 such that the second preset marker remains within a central region of the image captured by the imaging device 281 that contains the second preset marker. For instance, a geometric center of the second preset marker (e.g., a circle center) can be maintained at the center of the image.

In some embodiments, in order to ensure a precise landing of the UAV 20, the flight control device 24 can direct the imaging device 281 to continuously capture images of the second preset marker and adjust the flight parameters of the UAV 20 in real-time based upon the second preset marker and the spatial distance, such that the UAV 20 can precisely land onto the landing area 314 of the target aerial platform 30.

In some embodiments, if the second preset marker is not recognized from the captured images, the flight control device 24 can adjust the flight parameters of the UAV 20 in the vertical direction based upon the altitude information of the UAV 20 and the target aerial platform 30 to direct the UAV 20 to move above the target aerial platform 30. In the meantime, the flight control device 24 can direct the imaging device 281 to capture new images of the target aerial platform 30 until the second preset marker is recognized from the new images. This can avoid the situation where the imaging device 281 cannot capture the second preset marker of the target aerial platform 30 when the UAV 20 is below the target aerial platform 30.

In some embodiments, the flight control device 24 can recognize the first preset marker or the second preset marker from the captured images based upon a fitting error of contour of grayscale image.

An airborne replenishment can be provided to the UAV 20 by the target aerial platform 30 when the UAV 20 is landed on the landing area 314 of the target aerial platform 30.

The resource supplement provided by the target aerial platform 30 can include, but not limited to, wired or wireless battery charging for the UAV 20, changing the battery of the UAV 20, replacing the load (for example, the imaging device or a sensing device) onboard the UAV 20, or refilling/replacing a raw material carried by the UAV 20 (for example, oil, gas, water, solvent, or powder).

In some embodiments, the target aerial platform 30 can provide airborne replenishment to power the UAV 20. The communication information received by the first wireless communication device 22 from the target aerial platform 30 can include at least the position information or the altitude information of the target aerial platform 30. The flight control device 24 can determine an effective wireless charging area based upon the position information and altitude information of the UAV 20 and the target aerial platform 30. The flight control device can adjust flight parameters of the UAV 20 to direct the UAV 20 to autonomously move into the effective wireless charging area to receive wireless charging from the target aerial platform 30. Additionally or alternatively, the flight control device 24 can direct the target aerial platform 30 to move toward the UAV 20 by sending the flight control signal to the target aerial platform 30 through the first wireless communication device 22, such that the UAV 20 can be within the effective wireless charging area to receive wireless charging from the target aerial platform 30.

In some instances, the flight control device 24 can generate a charging control signal when the UAV 20 is within the effective wireless charging area. The power receiving device 251 of the UAV 20 and the power transmission device 316 of the target aerial platform 30 can establish a wireless connection in response to the charging control signal and wirelessly transmit an electric power. Therefore, wireless battery charging can be effected by a high frequency induction without landing the UAV 20 onto the target aerial platform 30 or removing the battery. In this way, the charging process can be simplified and an efficiency and intelligence of battery charging can be improved.

In some embodiments, once the wireless power transmission is effected between the power receiving device 251 of the UAV 20 and the power transmission device 316 of the target aerial platform 30, the flight control device 24 can adjust flight parameters of the UAV 20 to maintain the UAV 20 within the effective wireless charging area or direct the UAV 20 to land onto the landing area 314 of the target aerial platform 30 to avoid an energy consumption in maintaining a flight of the UAV 20.

With the method of providing airborne replenishment to the UAV 20 as discussed in the disclosure, a valid aerial platform 30 can be autonomously determined without human input, and the UAV 20 does not return to a ground station to receive resource supplement. Therefore, a time spent in landing the UAV 20 can be avoided, a flight range and an effective flight time of the UAV 20 can be increased, and an operating efficiency and intelligence of the UAV 20 can be increased. A range of operating the UAV 20 can thus be extended. For example, the UAV 20 can be operated in a variety of environments that are not suitable for deploying ground stations, such as over sea or in forest. In addition, a volume and weight of the battery onboard the UAV 20 can be reduced. A reliance of the UAV 20 on ground stations, a manual input, and a labor cost can be accordingly reduced.

FIG. 6 shows a structure of an aerial platform 30 in accordance with embodiments of the disclosure. As shown in FIG. 6, the aerial platform 30 includes a levitating device 301. The levitating device 301 can provide a levitation force to enable the aerial platform 30 to float in the air for a long time. In some embodiments, the levitating device 301 can include a plurality of independent airbags (not shown) filled with a gas having a density smaller than the air for generating a levitation force. In some instances, the gas can include hydrogen or helium. In some embodiments, the gas can be helium. In some embodiments, the aerial platform 30 can include an airship.

In some embodiments, the aerial platform 30 can include a hot-air balloon, a solar powered aerial device, or another device capable of hovering and/or moving in the air.

In some embodiments, as shown in FIG. 6, the aerial platform 30 further includes a second wireless communication device 302, a positioning device 3031, an altitude measurement device 3032, and a controller 304. The second wireless communication device 302 can wirelessly communicate with an unmanned aerial vehicle (UAV) 20 that receives a resource supplement. In some embodiments, the second wireless communication device 302 can wirelessly communicate with the UAV 20 through a wireless communication including but not limited to Bluetooth, GPS, WI-FI, 2G network, 3G network, 4G network, or 5G network.

In some embodiments, the positioning device 3031, such as a GPS positioning device, can obtain position information and altitude information of the aerial platform 30. The altitude measurement device 3032, such as a barometer, can measure altitude information of the aerial platform 30. The controller 304 can direct the second wireless communication device 302 to send the position information and the altitude information of the aerial platform 30 to the UAV 20.

In some embodiments, as shown in FIG. 6, the aerial platform 30 further includes a propulsion assembly 305 for providing a propulsion to the aerial platform 30. The controller 304 can adjust flight parameters of the aerial platform 30 by controlling a propulsion output of the propulsion assembly 305. In some embodiments, the propulsion assembly 305 can include an engine, a tail, a rudder, and an elevator for providing propulsion to effect taking off, landing, a horizontal movement, and hovering of the aerial platform 30.

In some embodiments, once a flight control signal is received from the UAV 20 by the second wireless communication device 302, the controller 304 can adjust flight parameters of the aerial platform by controlling the propulsion output of the propulsion assembly 305 to direct the aerial platform 30 in a direction toward the UAV 20.

The controller 304 can control the second wireless communication device 302 to communicate with the UAV 20 periodically or in real-time to obtain real-time communication information of the UAV 20 and provide the real-time communication information of the aerial platform 30 to the UAV 20. In some embodiments, the real-time communication information can include at least one of the position information and altitude information of the UAV 20 or a strength of the wireless signal transmitted from the UAV 20. The real-time communication information of the aerial platform 30 can comprise at least one of the position information and the altitude information of the aerial platform 30 or the strength of the wireless signal transmitted from the aerial platform 30.

The controller 304 can determine a flight direction of the aerial platform 30.

In some embodiments, the controller 304 can determine the flight direction of the aerial platform 30 based upon the position information and the altitude information of the UAV 20 and the aerial platform 30.

Alternatively, the controller 304 can determine the flight direction of the aerial platform 30 by determining a direction in which the strength of the wireless signal transmitted from the UAV 20 is increasing.

The controller 304 can adjust the flight parameters of the aerial platform 30 to terminate a flight of the aerial platform 30 if a flight termination signal sent from the UAV 20 is received by the second wireless communication device 302.

In some embodiments, a first preset marker can be provided in advance on at least one side of the aerial platform 30 for guiding a movement of the UAV 20 toward the aerial platform 30. In some embodiments, the first preset marker can be provided on more than one side of the aerial platform 30 to facilitate the imaging device 281 of the UAV 20 to capture the first preset marker. This configuration can avoid a situation where the imaging device 281 cannot capture the first preset marker when the UAV 20 and the first preset marker are positioned at different sides of the target aerial platform 30.

In some embodiments, an airship can be employed as the aerial platform 30. The airship can carry a heavy load and float or move in the air by levitation force for an extended period of time. A stable platform can be provided to effect airborne replenishment to the UAV 20 without a fuel consumption. The UAV 20 can land onto and interact with the airship. The airship can serve as a movable power refilling station by carrying resource supplement and autonomously provide resource supplement to the UAV 20.

In some embodiments, as shown in FIG. 6, the aerial platform 30 further includes a replenishment station 31. In some embodiments, the replenishment station 31 can include a battery charging station or a battery changing station. In some embodiments, the replenishment station 31 can include a load replacing station or a raw material refilling station. The replenishment station 31 include a carrier base 311, a guiding member 312, and a replenishment device 313. In some embodiments, the carrier base 311 can carry the resource supplement and can be provided with a landing area 314 onto which the UAV 20 is landed. In some embodiments, a second preset marker can be provided in advance on the landing area 314 for guiding a precise landing of UAV 20 onto the landing area 314 of the replenishment station 31.

The guiding member 312 can be movably provided in the landing area 314 for guiding the UAV 20 to the landing area 314. In some embodiments, the guiding member 312 can define a part of the landing area 314, such that a size of the landing area 314 can be changed by a deformation of the guiding member 312. For example, the guiding member 312 can translate in the landing area 314 to change the size of the landing area 314. As another example, the guiding member 312 can include a retractable member that can change the size of the landing area 314 by an extension and retraction of the guiding member 312.

In some embodiments, the guiding member 312 can be in an operational state to guide the UAV 20 to the landing area 314, such that the UAV 20 can land precisely onto the landing area 314. The guiding member 312 can be transformed to a non-operational state if the UAV 20 is away from the replenishment station 31, such that an overall volume of the replenishment station 31 is reduced. In some embodiments, a profile of the guiding member 312 in the operational state can be different from a profile of the guiding member 312 in the non-operational state.

The replenishment station 31 is not limited to the example described in the illustrative embodiments. The replenishment station 31 can be provided with other configurations as long as the replenishment station 31 can autonomously change a battery of the UAV 20 or charge a battery of the UAV 20.

When the UAV 20 to receive the resource supplement is positioned within the landing area 314 of the replenishment station 31, for example, after the UAV 20 is landed onto the landing area 314 and is positioned with an assistance of the guiding member 312, the controller 304 can direct the replenishment device 313 to provide resource supplement to the UAV 20.

In some embodiments, the replenishment device 313 can include a changing device for changing the battery of the UAV 20. In some embodiments, as shown in FIG. 6, the replenishment station 31 further includes a battery station 315 for storing and charging the battery of the UAV 20. In some instances, the battery station 315 can include a plurality of battery compartments, each of which can be provided with an opening. An inner wall of the opening of each of the battery compartments can be provided with an engaging structure, which engages with the battery to position the battery in the battery compartment. In some instances, a charging device for charging the battery of the UAV 20 can be provided in each of the battery compartments. The charging device can include a contactless charging device including an electromagnetic induction circuit, a magnetic resonance induction circuit, or a microwave induction circuit. In some embodiments, the charging device can include a contact charging device including a charging contact provided on the inner wall of the opening of each of the battery compartments. The charging contact of the opening can correspond to a charging contact of the battery.

In some embodiments, the replenishment device 313 can include an auxiliary mechanism to assist in positioning the UAV 20. In some instances, the auxiliary mechanism can be retractable with respect to the landing area 314 to push the UAV 20, until the UAV 20 is positioned in place by the landing area 314 and the auxiliary mechanism. In some embodiments, the auxiliary mechanism can clamp the UAV 20 to position the UAV 20 in place. In some embodiments, the auxiliary mechanism can include a grasping mechanism for grasping the battery of the UAV 20 and a clamping mechanism for positioning the UAV 20. The auxiliary mechanism is not limited to the example described hereinabove and can be designed according to actual needs. For example, the auxiliary mechanism can include a robotic arm.

In some embodiments, the replenishment device 313 can include a raw material refilling device for refilling a functional raw material for the UAV 20.

In some instances, the raw material refilling device can include an interface for transferring a liquid material. The interface for transferring a liquid material can refill the UAV 20 with a liquid material such as gasoline, a detergent, or a pesticide.

In some embodiments, the raw material refilling device can include a device for transferring a solid material. For example, the device for transferring a solid material can include a pesticide conveyor or a cartridge holding device if a spray device for spraying a powdery pesticide is carried onboard the UAV 20. The device for transferring a solid material can refill the UAV 20 with a solid material such as a powdery pesticide or an extinguishing powder.

In some embodiments, the replenishment device 313 can include a load replacing device for replacing a load of the UAV 20. In some instances, the load replacing device can include an auxiliary mechanism for replacing a gimbal onboard the UAV 20. In some embodiments, the load replacing device can include an auxiliary mechanism for replacing an ultrasonic cleaning device carried onboard the UAV 20.

In some embodiments, as shown in FIG. 6, the replenishment station 31 further includes a power transmission device 316. The power transmission device 316 can be coupled to a power receiving device 251 provided on the UAV 20 and transmit power to the power receiving device 251. In some instances, the power transmission between the power transmission device 316 and the power receiving device 251 provided on the UAV 20 can be effected through a wireless connection. In this way, the positioning device for assisting in positioning the UAV 20 onto the landing area 314 of the aerial platform 30 can be omitted from the UAV 20 and the aerial platform 30.

In some embodiments, the controller 304 can direct the power transmission device 316 to establish a wireless connection with the power receiving device 251 provided on the UAV 20 and effect a wireless power transmission when the UAV 20 has landed onto the landing area 314 of the replenishment station 31 or when the UAV 20 is within the effective wireless charging area. Therefore, a precise landing of the UAV 20 onto the landing area 314 of the aerial platform 30 is not necessary. In some instances, landing of the UAV 20 onto the aerial platform 30 is not necessary. Battery charging can be effected by a high frequency induction without changing the battery. In this way, the charging process can be simplified, and an efficiency and intelligence of battery charging can be improved.

In some embodiments, as shown in FIG. 6, the replenishment station 31 further includes a detection device 317 for detecting a state of the replenishment station 31. The controller 304 can direct the second wireless communication device 302 to send state information of the replenishment station 31 to the UAV 20, such that the UAV 20 can land on a valid replenishment station 31 to avoid waste of resources and flight time.

In some embodiments, the state of the replenishment station 31 can include at least one of a resource adequate and standby state, a resource adequate but busy state, or a resource inadequate state.

In some embodiments, the detection device 317 can include an imaging device (now shown) onboard the replenishment station 31. The imaging device can capture an image of the landing area 314 of the replenishment station 31 to determine whether a UAV 20 is landed on the replenishment station 31, thereby determining whether the replenishment station 31 is in a standby state or a busy state.

In some embodiments, the detection device 317 can include a power detection circuit. The power detection circuit can detect a remaining power of a power source onboard the replenishment station 31, thereby determining whether the replenishment station 31 can provide sufficient electric power.

In some embodiments, the detection device 317 can include a raw material amount detection device. The raw material amount detection device can detect a remaining amount of a raw material carried by the replenishment station 31, thereby determining whether the replenishment station 31 can provide sufficient raw material.

In some embodiments, the controller 304 can send a landing signal to the aerial platform 30 if the detection device 317 detects that the replenishment station 31 is in the resource inadequate state. The aerial platform 30 can autonomously return to ground in response to the landing signal to refill resource supplement such as power, a load, or a raw material.

In some embodiments, the controller 304 can set the state of the replenishment station 31 to a busy state if a supplement demand signal is received from the UAV 20 by the second wireless communication device 302 and/or the UAV 20 is landed on the landing area 314. In this way, the replenishment station 31 may not be determined as the target replenishment station by two or more UAVs 20, and thus a conflict and waste of resources can be prevented. The controller 304 can direct a corresponding functional device of the replenishment station 31 to prepare for providing resource supplement based on a type of the supplement demand signal.

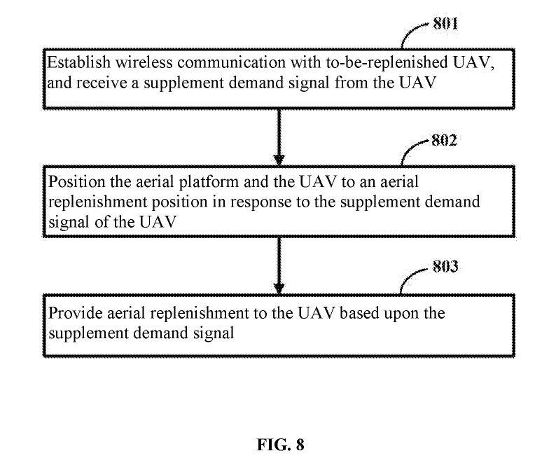

FIG. 8 shows a flow chart of a method of controlling an aerial platform 30 in accordance with embodiments of the disclosure. The method of controlling the aerial platform 30 can be used to control the aerial platform described hereinabove.

As shown in FIG. 8, at 801, a wireless communication with an unmanned aerial vehicle (UAV) 20 that is to receive the resource supplement (also referred to as a to-be-replenished UAV 20, is established, and a supplement demand signal from the UAV 20 is received.

In some embodiments, when a flight control signal from the to-be-replenished UAV 20 is received, the second wireless communication device 302 can communicate with the to-be-replenished UAV 20 periodically or in real-time to obtain real-time communication information of the to-be-replenished UAV 20 and provide the real-time communication information of the aerial platform 30 to the to-be-replenished UAV 20.

The real-time communication information of the to-be-replenished UAV 20 can include at least one of position information and altitude information of the to-be-replenished UAV 20, or a strength of a wireless signal transmitted from the to-be-replenished UAV 20. The real-time communication information of the target aerial platform 30 can include at least one of position information and altitude information of the target aerial platform 30, or a strength of a wireless signal transmitted from the target aerial platform 30.

At 802, the aerial platform 30 and the UAV 20 are positioned to an airborne replenishment position in response to the supplement demand signal of the UAV 20.

The airborne replenishment position can include but not limited to a position where the aerial platform 30 can charge a battery of the UAV 20 in a wired manner, a position where the aerial platform 30 can charge a battery of the UAV 20 in a wireless manner, a position where the aerial platform 30 can replace a battery of the UAV 20, or a position where the aerial platform 30 can replace and/or refill a raw material for the UAV 20.

The controller 304 can determine a flight direction of the aerial platform 30.

In some embodiments, the controller 304 can determine the flight direction of the aerial platform 30 based upon the position information and the altitude information of the to-be-replenished UAV 20.

In some embodiments, the controller 304 can determine the flight direction of the aerial platform 30 by determining a direction in which the strength of the wireless signal transmitted from the to-be-replenished UAV 20 is increasing.

In some embodiments, the controller 304 can adjust the flight parameters of the aerial platform 30 to terminate a flight of the aerial platform 30 if a flight termination signal sent from the to-be-replenished UAV 20 is received by the second wireless communication device 302.

At 803, an airborne replenishment can be provided to the UAV based upon the supplement demand signal.

The airborne replenishment can include but not limited to charging a battery of the UAV 20 in a wired manner, charging a battery of the UAV 20 in a wireless manner, changing the battery of the UAV 20, or refilling/changing the raw material for the UAV 20.

The embodiments as discussed hereinabove are merely examples of the disclosure. In view of the disclosure on illustrative embodiments, it will be apparent to those skilled in the art that the disclosed methods can be implemented by means of software plus generic hardware platforms or by means of hardware. With this understanding, part or entire of a method consistent with the disclosure can be embodied in software product. The software product can be stored in a storage medium (for example, a ROM/RAM, a magnet disk or an optical disk). The software product can include instructions to direct a terminal device (for example, a cell phone, a computer, a server or a network device) to perform the method consistent with the disclosure, such as one of the example methods described above.

The foregoing embodiments are intended to merely illustrate rather than limit the disclosure. While some embodiments of the disclosure have been shown and described herein, it will be obvious to those skilled in the art that such embodiments are provided by way of example only. Numerous variations and substitutions will occur to those skilled in the art without departing from the scope of the disclosure.

What is claimed is:

1. An unmanned aerial vehicle (UAV) comprising:
a detection device configured to generate a supplement demand signal in response to a need of the UAV for resource supplement;
a wireless communication device configured to establish a wireless communication connection with at least one aerial platform and communicate with the at least one aerial platform in response to the supplement demand signal being generated; and
a flight control device configured to:
determine a target aerial platform from the at least one aerial platform,
generate a flight control signal based upon communication information of the target aerial platform received by the wireless communication device, and
adjust a spatial distance between the UAV and the target aerial platform based upon the flight control signal to enable an airborne replenishment to the UAV by the target aerial platform.

2. The UAV of claim 1, wherein the supplement demand signal includes a power supplement demand signal generated by the detection device in response to detecting that a capacity of a battery of the UAV is below a preset threshold.

3. The UAV of claim 2, further comprising:
a positioning device configured to obtain position information of the UAV; and
an altitude measurement device configured to measure altitude information of the UAV, wherein:
the communication information of the target aerial platform includes position information and altitude information of the target aerial platform,
the flight control device is further configured to:
determine an effective wireless charging area based upon the position information and the altitude information of the UAV and the position information and the altitude information of the target aerial platform, and
perform at least one of adjusting flight parameters of the UAV to direct the UAV to move toward the target aerial platform or sending the flight control signal to the target aerial platform through the wireless communication device to direct the target aerial platform to move toward the UAV, such that the UAV enters the effective wireless charging area to receive wireless charging provided by the target aerial platform.

4. The UAV of claim 3, further comprising:
a power receiving device,
wherein the flight control device is further configured to generate a wireless charging signal in response to the UAV entering the effective wireless charging area to establish a wireless connection between the power receiving device and a power transmission device of the target aerial platform.

5. The UAV of claim 1, wherein the flight control device is further configured to adjust flight parameters of the UAV to direct the UAV to land onto a landing area of the target aerial platform.

6. The UAV of claim 5, further comprising:
a positioning device configured to measure position information of the UAV; and
an altitude measurement device configured to measure altitude information of the UAV,
wherein the flight control device is further configured to:
direct the wireless communication device to receive communication information of the target aerial platform from the target aerial platform, the communication information of the target aerial platform includes at least one of:
position information and altitude information of the aerial platform, or
a strength of a wireless signal transmitted from the target aerial platform, determine a flight direction of the UAV based upon:
the position information and the altitude information of the UAV and the position information and the altitude information of the target aerial platform, and/or
a direction in which the strength of the wireless signal transmitted from the target aerial platform is increasing.

7. The UAV of claim 6, wherein the flight control device is further configured to calculate the spatial distance between the UAV and the target aerial platform based upon:
the position information and the altitude information of the UAV and the position information and the altitude information of the target aerial platform, and/or
the strength of the wireless signal transmitted from the target aerial platform.

8. The UAV of claim 7, wherein the flight control device is further configured to, in response to the spatial distance between the UAV and the target aerial platform being less than or equal to a preset distance:
direct an imaging device onboard the UAV to capture an image of a surrounding environment,
analyze the captured image to recognize a preset marker on at least one side of the target aerial platform,
determine a position of the target aerial platform based upon the preset marker, and
adjust the flight parameters of the UAV according to a guidance configured in the preset marker to direct the UAV to move in a direction toward the position of the target aerial platform.

9. The UAV of claim 8, wherein the flight control device is further configured to, in response to the spatial distance between the UAV and the target aerial platform being less than or equal to a threshold distance shorter than the preset distance, adjust the flight parameters of the UAV in a vertical direction to land the UAV onto the landing area of the target aerial platform based upon the altitude information of the UAV and the altitude information of the target aerial platform.

10. The UAV of claim 9, wherein:
the preset marker is a first preset marker, and
the flight control device is further configured to:
direct the imaging device to capture an image of the target aerial platform and analyze the image to recognize a second preset marker on the landing area,
determine a position of the landing area based upon the second preset marker, and
adjust the flight parameters of the UAV according to a guidance configured in the second preset marker to direct the UAV to land onto the landing area.

11. The UAV of claim 1, wherein the flight control device is further configured to:
calculate a spatial distance between the UAV and each of at least one of the at least one aerial platform based upon communication information from the each of the at least one of the at least one aerial platform, and
determine one of the at least one of the at least one aerial platform that has a shortest spatial distance to the UAV as the target aerial platform.

12. The UAV of claim 11, wherein the communication information of each of the at least one of the at least one aerial platform includes state information indicating the corresponding aerial platform has adequate resource and is standby.

13. A method of providing airborne replenishment to an unmanned aerial vehicle (UAV), comprising:
generating a supplement demand signal in response to a need of the UAV for resource supplement;
establishing a wireless communication connection with at least one aerial platform and communicating with the at least one aerial platform in response to the supplement demand signal being generated;
determining a target aerial platform from the at least one aerial platform;
generating a flight control signal based upon communication information of the target aerial platform received from the target aerial platform; and
adjusting a spatial distance between the UAV and the target aerial platform based upon the flight control signal to enable the airborne replenishment to the UAV by the target aerial platform.

14. The method of claim 13, wherein the supplement demand signal includes a power supplement demand signal generated in response to detecting that a capacity of a battery onboard the UAV is below a preset threshold.

15. The method of claim 14,
wherein the communication information received from the target aerial platform includes at least position information and altitude information of the target aerial platform,
the method further comprising:
obtaining position information and altitude information of the UAV;
determining an effective wireless charging area based upon the position information and the altitude information of the UAV and the position information and the altitude information of the target aerial platform;
performing at least one of:
adjusting flight parameters of the UAV to direct the UAV to move into the effective wireless charging area to receive wireless charging provided by the target aerial platform, or
sending the flight control signal to the target aerial platform to direct the target aerial platform to move toward the UAV, such that the UAV is within the effective wireless charging area to receive the wireless charging provided by the target aerial platform.

16. The method of claim 13, further comprising:
adjusting flight parameters of the UAV to direct the UAV to land onto a landing area of the target aerial platform to receive the airborne replenishment provided by the target aerial platform.

17. The method of claim 16, further comprising:
obtaining position information and altitude information of the UAV, and calculating the spatial distance between the UAV and the target aerial platform based upon the position information and the altitude information of the UAV and position information and altitude information of the target aerial platform; and/or
calculating the spatial distance between the UAV and the target aerial platform based upon a strength of a wireless signal transmitted from the target aerial platform.

18. The method of claim 17, further comprising, in response to the spatial distance between the UAV and the target aerial platform being less than or equal to a preset distance:
directing an imaging device onboard the UAV to capture an image of a surrounding environment;
analyzing the image to recognize a preset marker on at least one side of the target aerial platform;
determining a position of the target aerial platform based upon the preset marker; and
adjusting the flight parameters of the UAV according to a guidance configured in the preset marker to direct the UAV to move in a direction toward the position of the target aerial platform.

19. The method of claim 18, further comprising, in response to the spatial distance between the UAV and the target aerial platform being less than or equal to a threshold distance shorter than the preset distance:
adjusting the flight parameters of the UAV in a vertical direction to land the UAV onto the landing area of the target aerial platform based upon the altitude information of the UAV and the altitude information of the target aerial platform.

20. The method of claim 19,
wherein the preset marker is a first preset marker,
the method further comprising:
directing the imaging device to capture an image of the target aerial platform and analyzing the image to recognize a second preset marker on the landing area; and
determining a position of the landing area based upon the second preset marker; and
adjusting the flight parameters of the UAV according to a guidance configured in the second preset marker to direct the UAV to land onto the landing area.
